(19) United States
(12) Patent Application Publication
(10) Pub. No.: US 2025/0368459 A1
(43) Pub. Date: Dec. 4, 2025

(54) RAW MATERIAL INPUT APPARATUS AND RAW MATERIAL INPUT METHOD

(71) Applicant: SK On Co., Ltd., Seoul (KR)

(72) Inventors: Se Young LEE, Daejeon (KR); Jong Beom PARK, Daejeon (KR); Seong Yun JEONG, Daejeon (KR); Dong Geun HAN, Daejeon (KR)

(21) Appl. No.: 19/070,525

(22) Filed: Mar. 5, 2025

(30) Foreign Application Priority Data
May 31, 2024 (KR) 10-2024-0071351

(51) Int. Cl. B65G 65/40

(52) U.S. Cl. CPC B65G 65/40; B65G 2201/042

(57) ABSTRACT

Proposed is a raw material input apparatus, including a main body part moving a material contained in a container through an internal flow path, an inlet part penetrated at a side of the main body part to communicate with the internal flow path, and an input part connected to the inlet pert so as to be erected vertically, penetrated to communicate with the internal flow path, and having a sharp first end.

### CROSS REFERENCE TO RELATED APPLICATION

The present application claims priority to Korean Patent Application No. 10-2024-0071351, filed May 31, 2024, the entire contents of which is incorporated herein for all purposes by this reference.

### BACKGROUND OF THE INVENTION

### Field of the Invention

The present disclosure relates to a raw material input apparatus and a raw material input method.

### Description of the Related Art

In recent years, there has been increasing demand for portable electronic products such as laptop computers, video cameras, and smartphones, and the development of electric vehicles, energy storage batteries, robots, satellites, and the like has begun in earnest. As an eco-friendly energy source used as a driving power source, secondary batteries are experiencing a rapid increase in demand and require a lot of research and development.

Secondary batteries are made of materials that can be repeatedly oxidized and reduced, such as lithium (Li), cobalt (Co), nickel (Ni), and molybdenum (Mo). Unlike primary batteries, secondary batteries can be repeatedly charged and used.

During a manufacturing process of secondary batteries, powder-type active materials such as lithium (Li), cobalt (Co), nickel (Ni), and molybdenum (Mo), which are raw materials for secondary batteries, need to be transferred to an active material mixing process to mix them.

The foregoing is intended merely to aid in the understanding of the background of the present disclosure, and is not intended to mean that the present disclosure falls within the purview of the related art that is already known to those skilled in the art.

### Documents of Related Art

(Patent document 1) Korean Patent No. 10-0873658

### SUMMARY OF THE INVENTION

Accordingly, the present disclosure has been made keeping in mind the above problems occurring in the related art, and an objective of the present disclosure is to provide a raw material input apparatus and a raw material input method that can solve the problem of contamination of a work area caused by material scattering when an active material is input and increase the input speed of the active material.

Another objective of the present disclosure is to provide a raw material input apparatus and a raw material input method that can be widely applied in green technology fields such as eco-friendly electric vehicles, hybrid vehicles, battery charging stations, solar and wind power generation using batteries, and the like to prevent climate change by suppressing air pollution and greenhouse gas emissions.

In order to achieve the above objectives, according to an aspect of the present disclosure, there is provided a raw material input apparatus, including: a main body part configured to move a material contained in a container through an internal flow path; an inlet part penetrated at a side of the main body part to communicate with the internal flow path; and an input part connected to the inlet part so as to be erected vertically, penetrated to communicate with the internal flow path, and having a sharp first end.

The input part may include a body portion provided with an inclined portion that is formed at the first end thereof and gradually becomes closer to the inlet part from a first edge of the first end to an opposite second edge of the first end.

The input part may include: a pointed sharp portion on the first edge of the first end of the body portion; and a concave cut-prevention portion on the second edge of the first end of the body portion.

The inclined portion of the first end of the body portion may include: a curved first inclined portion; and a second inclined portion continuously extended from the first inclined portion and inclined at a different angle from the first inclined portion.

The input part may include: a coupling portion bent at a second end thereof opposite to the first end; and a coupling member configured to allow the coupling portion to be coupled to the main body part.

The coupling portion may be provided with a plurality of bent portions, and the coupling portion may include a scattering particle collection hole penetrated at one of the plurality of bent portions.

The scattering particle collection hole may communicate with the internal flow path of the main body part.

The raw material input apparatus may further include: a sealing portion configured to be detachably coupled to a periphery of the coupling portion.

The sealing portion may have a band shape, and may include one or more materials from among natural rubber, chloroprene rubber, nitrile rubber, butyl rubber, ethylene propylene rubber, urethane rubber, silicone rubber, and fluorine rubber.

The raw material input apparatus may further include: a sealing portion that includes a power portion provided at the main body part and configured to generate power, a pressurizing portion configured to be movable by the power portion, and a support portion provided on a periphery of the coupling portion and configured to be closely coupled to the pressurizing portion when the pressurizing portion is moved.

According to another aspect of the present disclosure, there is provided a raw material input method, including: a transfer step in which a transfer part transfers a container to an upper side of a main body part; and an inner skin cutting step in which the transfer part drops the container toward an input part placed on the upper side of the main body part.

The raw material input method may further include: an outer skin fixing step in which an outer skin of the container is sealed and fixed to a boundary between the main body part and the input part using a sealing portion between the transfer step and the inner skin cutting step.

The outer skin of the container may externally surround and seal the input part.

The features and advantages of the present disclosure will be more clearly understood from the following detailed description when taken in conjunction with the accompanying drawings.

All terms or words used in the specification and claims have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

According to the present disclosure, it is possible to increase the efficiency of inputting an active material.

In addition, it is possible to prevent agglomeration of the active material.

In addition, it is possible to improve the working environment by preventing scattering of the active material.

In addition, it is possible to increase the input speed of the active material.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a front view schematically illustrating a raw material input apparatus according to an embodiment of the present disclosure;

FIG. 2 is a front view separately illustrating only an input part of FIG. 1;

FIG. 3 is a plan view of FIG. 2;

FIG. 4 is a use state view illustrating inputting a raw material by using the raw material input apparatus according to the embodiment of the present disclosure;

FIG. 5 is an enlarged left side view of FIG. 4, illustrating a part where the raw material is input;

FIG. 6 is a sectional view schematically illustrating an input flow of the raw material taken along line A-A′ of FIG. 5;

FIG. 7 is a use state view illustrating inputting a raw material by using a raw material input apparatus according to another embodiment of the present disclosure;

FIG. 8 is a use state view illustrating sealing an outer skin by operating a sealing portion of FIG. 7; and

FIG. 9 is a flowchart illustrating a raw material input method according to an embodiment of the present disclosure.

### DETAILED DESCRIPTION OF THE INVENTION

The terminology used herein is for the purpose of describing particular embodiments only and is not intended to be limiting. As used herein, the singular forms are intended to include the plural forms as well, unless the context clearly indicates otherwise.

As for reference numerals associated with elements in the drawings, the same elements will be designated by the same reference numerals although the components are shown in different drawings, and similar elements will be designated by similar reference numerals.

The drawings may be schematic or exaggerated to illustrate embodiments. In this document, expressions “have”, “may have”, “includes”, or “may include” specify the presence of stated features (e.g., a numerical value, function, operation, or element such as a part), but do not preclude the presence of additional features.

Terms such as “one”, “other”, “another”, “first”, and “second”, etc. are used only to distinguish one element from another element, these elements should not be limited by these terms.

Hereinbelow, exemplary embodiments of the present disclosure will be described in detail with reference to the accompanying drawings.

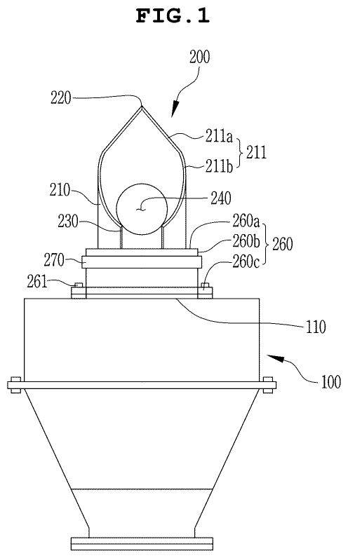

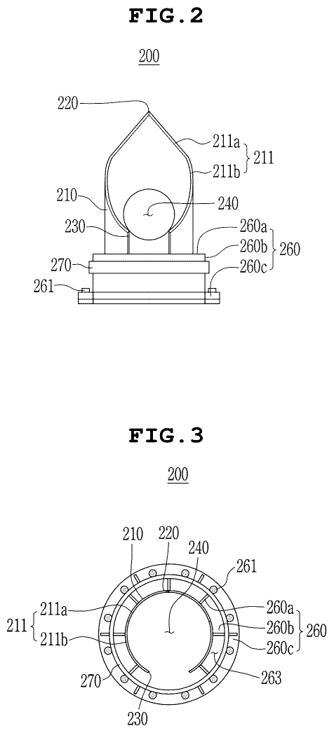

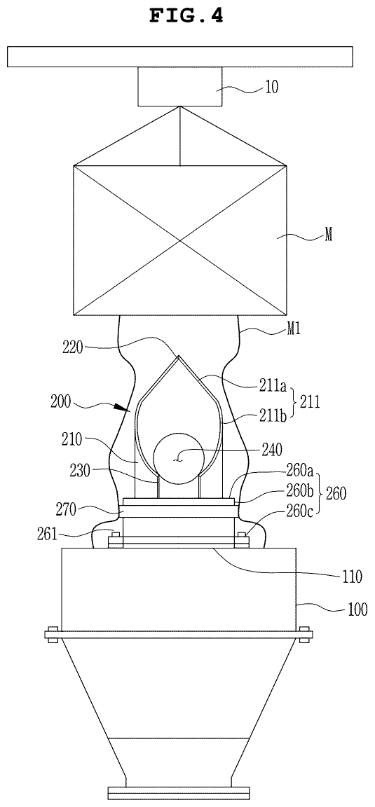

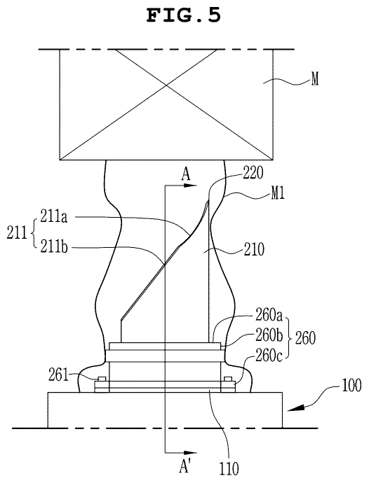

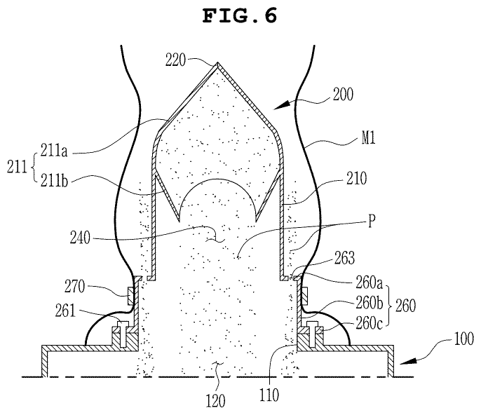

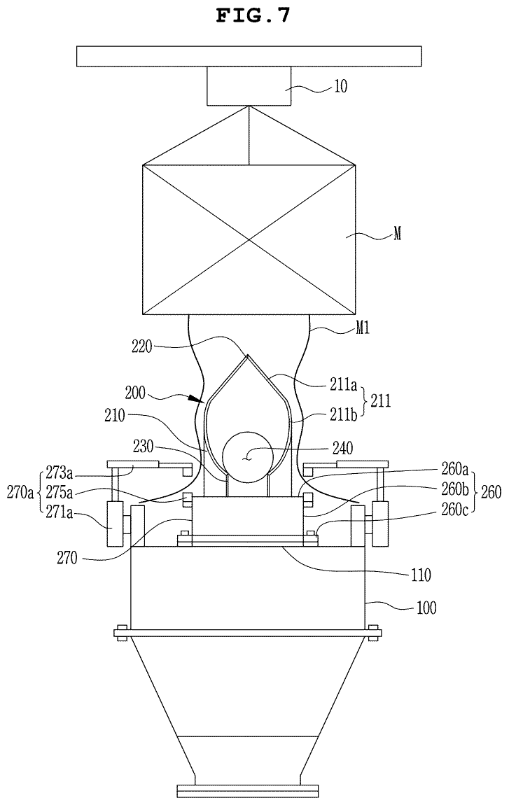

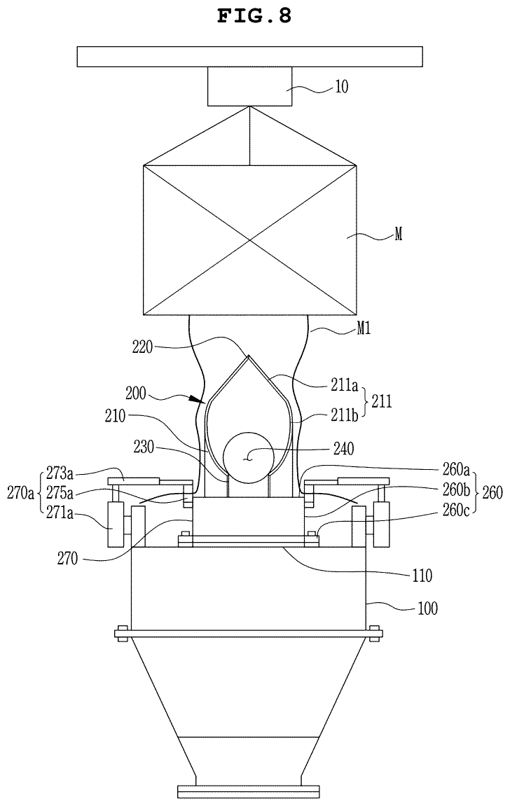

FIG. 1 is a front view schematically illustrating a raw material input apparatus according to an embodiment of the present disclosure. FIG. 2 is a front view separately illustrating only an input part of FIG. 1. FIG. 3 is a plan view of FIG. 2. FIG. 4 is a use state view illustrating inputting a raw material by using the raw material input apparatus according to the embodiment of the present disclosure. FIG. 5 is an enlarged left side view of FIG. 4, illustrating a part where the raw material is input. FIG. 6 is a sectional view schematically illustrating an input flow of the raw material taken along line A-A′ of FIG. 5. FIG. 7 is a use state view illustrating inputting a raw material by using a raw material input apparatus according to another embodiment of the present disclosure. FIG. 8 is a use state view illustrating sealing an outer skin by operating a sealing portion of FIG. 7.

As illustrated in FIGS. 1 to 6, the raw material input apparatus according to the embodiment of the present disclosure may include: a main body part 100 moving a material contained in a container M through an internal flow path 120; an inlet part 110 penetrated at a side of the main body part 100 to communicate with the internal flow path 120; and an input part 200 connected to the inlet part 110 so as to be erected vertically, penetrated to communicate with the internal flow path 120, and having a sharp first end.

The main body part 100 may provide a path for guiding an electrode active material P, which is a material contained in the container M, to a subsequent process.

The main body part 100 may have a cylindrical shape with an open first end (upper end) and an open second end (lower end) opposite to the first end.

The main body part 100 may include the internal flow path 120 that connects the first end and the second end of the main body part 100 to communicate with each other.

For reference, the container M may be a packaging material widely used for the purpose of loading and transferring granular or powdery contents, and is also called a flexible container, a flexible bulk container, a ton bag, etc.

Without being limited thereto, it will be apparent to those skilled in the art that the present disclosure is applicable to various types of containers capable of storing/transferring contents.

Here, powder may be an electrode active material processed into a granular or powdery form required for manufacturing a secondary battery, and the electrode active material may include a cathode active material or an anode active material.

The active material P contained in the container M may be introduced through the first end of the main body part 100, moved through the internal flow path 120, and discharged through the second end of the main body part 100.

The inlet part 110 may allow the active material P contained in the container M to be input into the internal flow path 120 inside the main body part 100. The inlet part 110 may be penetrated at the first end (upper end) of the main body part 100 to communicate with the internal flow path 120. The inlet part 110 may be provided at the center of the first end (upper end) of the main body part 100.

The input part 200 may cut an inner skin of the container M. Referring to FIG. 6, the electrode active material P inside the container M may be came out through a cut portion of the inner skin and input into the internal flow path 120 inside the main body part 100.

The input part 200 may be connected to the inlet part 110 so as to be erected vertically, may be penetrated to communicate with the internal flow path 120, and may have a pointed sharp portion 220 at a first end thereof.

The input part 200 may include a body portion 210, the sharp portion 220, a cut-prevention portion 230, a coupling portion 260, and a sealing portion 270.

The body portion 210 may have a cylindrical shape. The body portion 210 may be provided with an inclined portion 211 that is formed at a first end thereof and gradually becomes closer to the inlet part 110 from a first edge of the first end to an opposite second edge of the first end.

The sharp portion 220 may be a blade that is sharply erected on the first edge of the first end of the body portion 210.

The cut-prevention portion 230 may be provided concavely on the second edge of the first end of the body portion 210.

The input part 200 may be provided with the inclined portion 211 between the sharp portion 220 and the cut-prevention portion 230, so the sharp portion 220 may have the highest height at the inclined portion 211, and the cut-prevention portion 230 may have the lowest height at the inclined portion 211.

The inclined portion 211 may include a first inclined portion 211a and a second inclined portion 211b.

The first inclined portion 211a may be extended from the sharp portion 220, and the second inclined portion 211b may be continuously extended from the first inclined portion 211a and connected to the cut-prevention portion 230.

Both the first inclined portion 211a and the second inclined portion 211b may be formed to be curved. The second inclined portion 211b may be formed at a different inclination angle from the first inclined portion 211a. The first inclined portion 211a may be inclined more steeply than the second inclined portion 211b.

Referring to FIG. 3, the first inclined portion 211a and the second inclined portion 211b may be curved to form a circle when viewed from a plane. The inclined portion 211 may have a “C” shape with a side opened by the concave cut-prevention portion 230.

The input part 200 may be provided with a central portion 240 that is penetrated vertically at the exact center thereof to communicate with the internal flow path 120 of the main body part 100.

As the inclined portion 211 is formed to be curved in a circular shape, the inner skin of the container M cut by the sharp portion 220 may be opened along the curved inclined portion 211, allowing the active material P inside the container M to fall into the inner flow path 120 of the main body part 100 through the perforated central portion 240 of the inclined portion 211.

In addition, the input part 200 may be provided with the cut-prevention portion 230 that is concavely formed by removing a part of the inclined portion 211 so that the inner skin of the container M cut by the sharp portion 220 and the inclined portion 211 is not completely cut but is connected to the remaining inner skin of the container M.

The cut-prevention portion 230 may prevent the inner skin of the container M cut by the sharp portion 220 and the inclined portion 211 from being completely cut and introduced into the internal flow path 120 of the main body part 100 through the penetrated central portion 240 together with the active material P.

Therefore, the raw material input apparatus according to the embodiment of the present disclosure may eliminate interference between cut packaging materials that may occur when the inner skin of the container M is cut.

In addition, the present disclosure may minimize a phenomenon in which the active material P accumulates and aggregates in the input part 200 due to bridging of powder that may occur by interference between the input part 200 that cuts the container M and the input active material P.

Therefore, the present disclosure may improve the automation of packaging material cutting and the input speed in a raw material input process of a secondary battery manufacturing process.

The coupling portion 260 may allow the input part 200 to be coupled to the main body part 100.

The coupling portion 260 may be provided to be vertically bent outward at a second end of the body portion 210, which is opposite to the first end having the inclined portion 211 of the input part 200.

The coupling portion 260 may be provided with a plurality of bent portions. The coupling portion 260 may include a scattering particle collection hole 263 penetrated at one of the plurality of bent portions.

The coupling portion 260 may be provided with a first bent portion 260a that is vertically bent outward from a lower end of the body portion 210.

The coupling portion 260 may be provided with a second bent portion 260b that is vertically bent from the first bent portion 260a toward the main body part 100.

The coupling portion 260 may be provided with a third bent portion 260c that is vertically bent outward from the second bent portion 260b.

A single or a plurality of scattering particle collection holes 263 may be penetrated at the first bent portion 260a. The scattering particle collection hole 263 may communicate with the internal flow path 120 of the main body part 100.

That is, the scattering particle collection hole 263 may minimize scattering of a raw material by guiding scattering particles generated when the active material P falls from the inside of the container M into the internal flow path 120 of the main body part 100 to be collected in the internal flow path 120.

The input part 200 may include a coupling member 261 that allows the coupling portion 260 to be coupled to the main body part 100.

The coupling member 261 may include a single or a plurality of coupling members 261, and may be at least one of a bolt, a nut, a pin, a rivet, and a bracket.

The coupling member 261 may be provided at the third bent portion 260c, and may be coupled to the inlet part 110 of the main body part 100.

The input part 200 may further include the sealing portion 270 that is detachably coupled to the outer periphery of the coupling portion 260.

In an embodiment, the sealing portion 270 may have a band shape.

The sealing portion 270 may include one or more materials from among natural rubber, chloroprene rubber, nitrile rubber, butyl rubber, ethylene propylene rubber, urethane rubber, silicone rubber, and fluorine rubber.

The sealing portion 270 may have elasticity to be elastically coupled along the periphery of the second bent portion 260b.

The sealing portion 270 may be sealingly coupled to an outer skin M1 of the container M while the outer skin M1 of the container M is positioned on the outer periphery of the second bent portion 260b so as to fix the outer skin M1 of the container M to the second bent portion 260b.

That is, the outer skin M1 of the container M may externally surround and seal the boundary between the container M and the input part 200.

Referring to FIGS. 7 and 8, in another embodiment, a sealing portion 270a may include a power portion 271a provided at an upper portion of a main body part 100, a pressurizing portion 273a moved by the power portion 271a, and a support portion 275a provided on the periphery of a second bent portion 260b.

The power portion 271a may be provided at the main body part 100, and may generate power. The power portion 271a may include a single or a plurality of hydraulic cylinders or electric motors.

The pressurizing portion 273a may be connected to an upper end of the power portion 271a so as to be erected vertically, and may be movable up and down by the power portion 271a. The pressurizing portion 273a may have an end vertically bent toward the support portion 275a.

The support portion 275a may be provided on the periphery of the second bent portion 260b of a coupling portion 260, and may be brought into close contact with the end of the pressurizing portion 273a moved downward by the power portion 271a.

While an outer skin M1 of a container M is positioned between the pressurizing portion 273a and the support portion 275a to fix the outer skin M1 of the container M to the second bent portion 260b, the sealing portion 270a may move the pressurizing portion 273a toward the support portion 275a to allow the outer skin M1 to be sealingly coupled to the boundary between the pressurizing portion 273a and the support portion 275a.

Therefore, the outer skin M1 of the container M may externally surround and seal the boundary between the container M and an input part 200.

When the container M is dropped toward a sharp portion 220 in a state in which the sealing portion 270a sealingly couples the outer skin M1 to the boundary between the container M and the input part 200, a lower portion of the container M may be cut by the sharp portion 220, allowing an active material P inside the container M to be introduced into an internal flow path 120 inside the main body part 100.

The outer skin M1 of the container M fixed by the sealing portion 270a may block external leakage of scattering particles of the powder-type active material P. The scattering particles of the active material P that remain without leaking to the outside by the outer skin M1 of the container M may be introduced into the internal flow path 120 of the main body part 100 through a scattering particle collection hole 263.

Therefore, the raw material input apparatus according to the present disclosure may effectively prevent the active material P as a raw material from scattering into an external work space, and eliminate the risk to workers due to dust that may occur when manually disassembling the inner skin of the container M in the related art, thereby enhancing worker safety.

Hereinbelow, a method for inputting a raw active material according to an embodiment of the present disclosure will be described in detail with reference to the accompanying drawings.

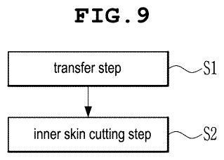

FIG. 9 is a flowchart illustrating a raw material input method according to an embodiment of the present disclosure.

As illustrated in FIG. 9, the raw material input method according to the embodiment of the present disclosure may include a transfer step S1 and an inner skin cutting step S2.

the raw material input method according to the embodiment of the present disclosure may include an outer skin fixing step between the transfer step S1 and the inner skin cutting step S2.

The transfer step S1 may be a step of transferring a container M to an upper side of a main body part 100 using a transfer part 10, such as a hoist crane.

In another embodiment of the present disclosure, the raw material input method may further include: an outer skin fixing step of sealingly fixing an outer skin M1 of the container M transferred in the transfer step S1 to the outer periphery of an input part 200 using a sealing portion 270. The outer skin M1 of the container M may externally surround and seal the input part 200.

The inner skin cutting step S2 may be a step of dropping the container M toward the input part 200 placed on the upper side of the main body part 100 using the transfer part 10.

An inner skin of the container M dropped toward the input part 200 may be cut when it hits a sharp portion 220 provided at an upper end of the input part 200 due to the load of the container M.

An active material M came out through a cut portion of the inner skin of the container M may be poured into a perforated central portion of the input part 200.

The active material M may be guided to an internal flow path 120 of the main body part 100 connected to the central portion of the input part 200 and moved to a subsequent process, such as an active material mixing process, through a perforated lower end of the main body part 100.

The present disclosure has been described in detail through specific embodiments. The embodiments are intended to specifically illustrate the present disclosure and are not intended to limit the scope of the appended claims. It will be apparent to those skilled in the art that various changes and modifications to the embodiments are possible within the scope and spirit of the present disclosure, and such changes and modifications fall within the scope of the appended claims.

What is claimed is:

1. A raw material input apparatus, comprising:
a main body part configured to move a material contained in a container through an internal flow path;
an inlet part penetrated at a side of the main body part to communicate with the internal flow path; and
an input part connected to the inlet part so as to be erected vertically, penetrated to communicate with the internal flow path, and having a sharp first end.

2. The raw material input apparatus of claim 1, wherein the input part comprises a body portion provided with an inclined portion that is formed at the first end thereof and gradually becomes closer to the inlet part from a first edge of the first end to an opposite second edge of the first end.

3. The raw material input apparatus of claim 2, wherein the input part comprises:
a pointed sharp portion on the first edge of the first end of the body portion; and
a concave cut-prevention portion on the second edge of the first end of the body portion.

4. The raw material input apparatus of claim 2, wherein the inclined portion of the first end of the body portion comprises:
a curved first inclined portion; and
a second inclined portion continuously extended from the first inclined portion and inclined at a different angle from the first inclined portion.

5. The raw material input apparatus of claim 1, wherein the input part comprises:
a coupling portion bent at a second end thereof opposite to the first end; and
a coupling member configured to allow the coupling portion to be coupled to the main body part.

6. The raw material input apparatus of claim 5, wherein the coupling portion is provided with a plurality of bent portions, and the coupling portion comprises a scattering particle collection hole penetrated at one of the plurality of bent portions.

7. The raw material input apparatus of claim 6, wherein the scattering particle collection hole communicates with the internal flow path of the main body part.

8. The raw material input apparatus of claim 5, further comprising:
a sealing portion configured to be detachably coupled to a periphery of the coupling portion.

9. The raw material input apparatus of claim 8, wherein the sealing portion has a band shape, and comprises one or more materials from among natural rubber, chloroprene rubber, nitrile rubber, butyl rubber, ethylene propylene rubber, urethane rubber, silicone rubber, and fluorine rubber.

10. The raw material input apparatus of claim 5, further comprising:
a sealing portion that comprises a power portion provided at the main body part and configured to generate power, a pressurizing portion configured to be movable by the power portion, and a support portion provided on a periphery of the coupling portion and configured to be closely coupled to the pressurizing portion when the pressurizing portion is moved.

11. A raw material input method, comprising:
a transfer step in which a transfer part transfers a container to an upper side of a main body part; and
an inner skin cutting step in which the transfer part drops the container toward an input part placed on the upper side of the main body part.

12. The raw material input method of claim 11, further comprising:
an outer skin fixing step in which an outer skin of the container is sealed and fixed to a boundary between the main body part and the input part using a sealing portion between the transfer step and the inner skin cutting step.

13. The raw material input method of claim 12, wherein the outer skin of the container externally surrounds and seals the input part.
